(19) United States
(12) Patent Application Publication
(10) Pub. No.: US 2016/0234764 A1
(43) Pub. Date: Aug. 11, 2016

(54) NEAR FIELD COMMUNICATION ASSISTED DEVICE AND SERVICE DISCOVERY

(71) Applicant: INTEL CORPORATION, Santa Clara, CA (US)

(72) Inventors: Carlos Cordeiro, Portland, OR (US); Emily H. Qi, Camas, WA (US); David J. McCall, Dallas, TX (US); Ganesh Venkatesan, Hillsboro, OR (US)

(73) Assignee: INTEL CORPORATION, Santa Clara, CA (US)

(21) Appl. No.: 15/026,752

(22) PCT Filed: Sep. 23, 2014
(86) PCT No.: PCT/US2014/057011

§ 371 Date: Apr. 1, 2016

Related U.S. Application Data
(60) Provisional application No. 61/916,385, filed on Dec. 16, 2013.

(51) Int. Cl. H04W 48/16; H04W 4/00; H04W 36/00

(52) U.S. Cl. CPC H04W 48/16; H04W 36/0011; H04W 4/008; H04W 84/12

(57) ABSTRACT

Disclosed herein are techniques to advertise and discover peer-to-peer services and connection attributes. In particular, services and connection attributes for a peer-to-peer network, like Wi-Fi Direct can be advertised and discovered using near field communication techniques by transmitting at least a handover select frame including an advertised services hash in the P2P attributes portion of the frame.

### RELATED CASES

This application claims the benefit of U.S. Provisional Application Ser. No. 61/916,385 filed Dec. 16, 2013, entitled “DEVICE AND METHODS FOR WI-FI DIRECT SERVICES WITH NFC,” which application is incorporated herein by reference in its entirety.

### TECHNICAL FIELD

Embodiments described herein generally relate to wireless communications and in particular to peer-to-peer device discovery and service discovery using near field communication.

### BACKGROUND

Many modern devices include networking capabilities. In particular, many devices include various communication and networking abilities. Modem applications are beginning to take advantage of this and provide for interconnectivity of such devices. For example, social networking applications, Internet of Things, wireless docking, etc., may provide for the interconnectivity of various devices. A variety of standards are used and/or proposed to facilitate such device connectivity. For example, Wi-Fi Direct, peer-to-peer, proximity discovery, or the like.

In order to provide mechanisms for such connection techniques, available services and connection attributes must be communicated. Typically, such services and attributes are discovered using Wi-Fi. As will be appreciated, using Wi-Fi to negotiate device and service discovery may be time consuming and may consume a significant amount of power.

### BRIEF DESCRIPTION OF THE DRAWINGS

FIG. 1 illustrates one embodiment of a peer-to-peer network.

FIGS. 2-3 illustrates embodiments of the peer-to-peer network of FIG. 1 in greater detail.

FIGS. 4-5 illustrate logic flows for embodiments of device and service discovery.

FIG. 6 illustrates one embodiment of a service and connection attribute discovery technique.

FIG. 7 illustrates one embodiment of a storage medium.

FIG. 8 illustrates one embodiment of a device.

FIG. 9 illustrates one embodiment of a wireless network.

### DETAILED DESCRIPTION

The present disclosure is generally directed to providing simple, convenient, and low power device and service discovery. More specifically, the present disclosure details various examples providing for the discovery of Wi-Fi devices and services (e.g., Wi-Fi Direct devices and services, or the like) using near field communication (NFC). For example, the present disclosure provides for a Wi-Fi Direct device to “pair” with another Wi-Fi Direct device using NFC.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

Various embodiments of the present disclosure may be included with or implemented by devices configured to operate in accordance with various wireless network standards. In some examples, these wireless network standards may include standards promulgated by the Wi-Fi Alliance, the Institute of Electrical Engineers (IEEE), or other standard setting organizations. With a particularly illustrative example, some embodiments may be implemented in accordance with the Wi-Fi Alliance, Wi-Fi Peer-to-Peer (P2P) Technical Specification with NFC, v1.3 2013 standard and/or the Wi-Fi Alliance, Wi-Fi Direct Services Technical Specification, v1.1 2011.

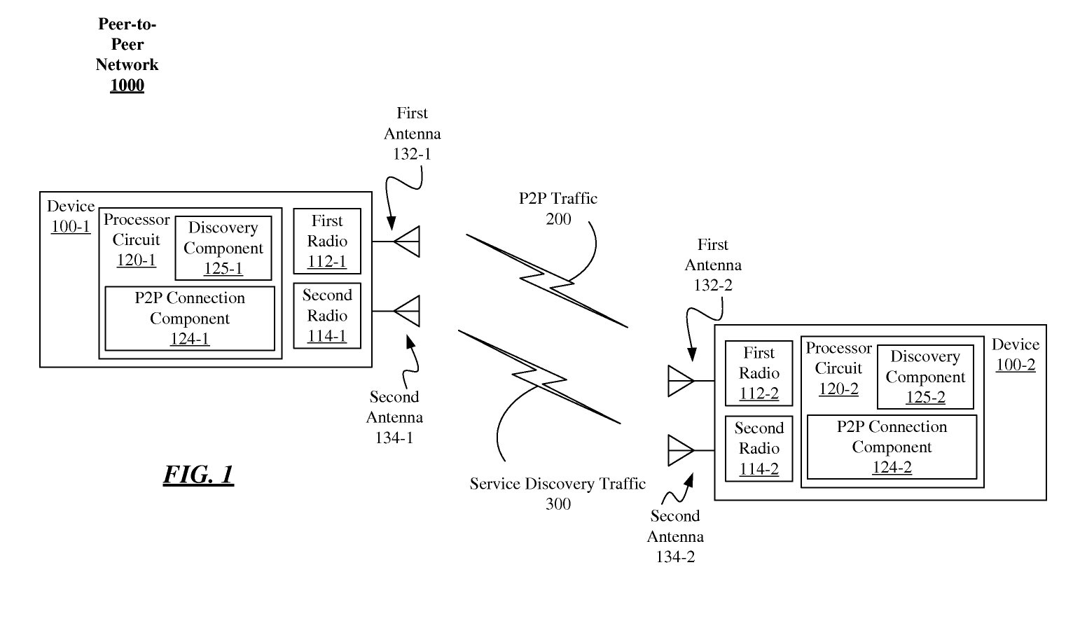

FIG. 1 illustrates a peer-to-peer (P2P) network 1000. The network 1000 includes devices 100-a, where “a” is a positive integer. In particular, devices 100-1 and 100-2 are shown. However, it is to be appreciated, that any number of devices 100-a may be implemented, and the number of devices depicted is merely shown at a quantity to facilitate understanding.

Each of the devices 100-a includes a first radio 112-a and a second radio 114-a. In general, the second radio 114-a may be implemented to discover other devices and the other devices' available services, which may be available using the first radio 112-a for purposes of communicating over the P2P network 1000.

For example, in some embodiments, the first radio 112-a may be a Wi-Fi radio, while the second radio 114-a may be an NFC radio. As another example, the first radio 112-a may be a WiGig radio, a ZigBee radio, an LTE radio, or in general, any radio used for network communication, while the second radio 114-a may be an NFC radio. It is to be appreciated that although the examples presented herein use an NFC radio as the second radio, this is not intended to be limiting. In particular, other communication technologies (e.g., RFID, or the like) may be used without departing from the present disclosure. Furthermore, each of the devices 100-a includes a first antenna (or antenna array) 132-a and a second antenna (or antenna array) 134-a. The first and second antennas 132-a and 134-a are operably connected to the first and second radios 112-a and 114-a, respectively. Additionally, it is to be appreciated that although not depicted, one of the devices 100-a may be provided with a single antenna (or antenna array) operably connected to both the first and second radios 112-a and 114-a.

Additionally, each of the devices 100-a includes a processor circuit 120-a operably coupled to the first and second radios 112-a and 114-a. In some examples, the processor circuit 120-a may be an application processor of the device 100-a. In some examples, the processor circuit 120-a may be a baseband processor of the device 100-a.

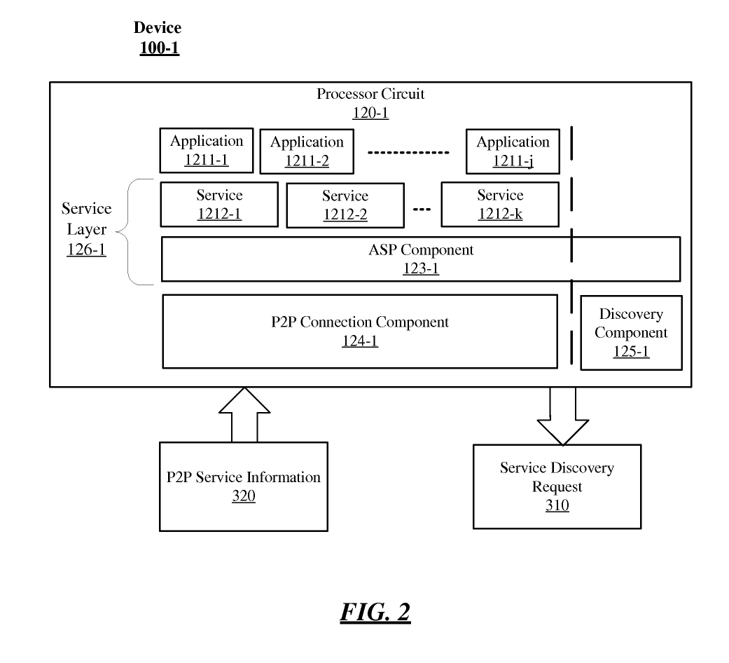

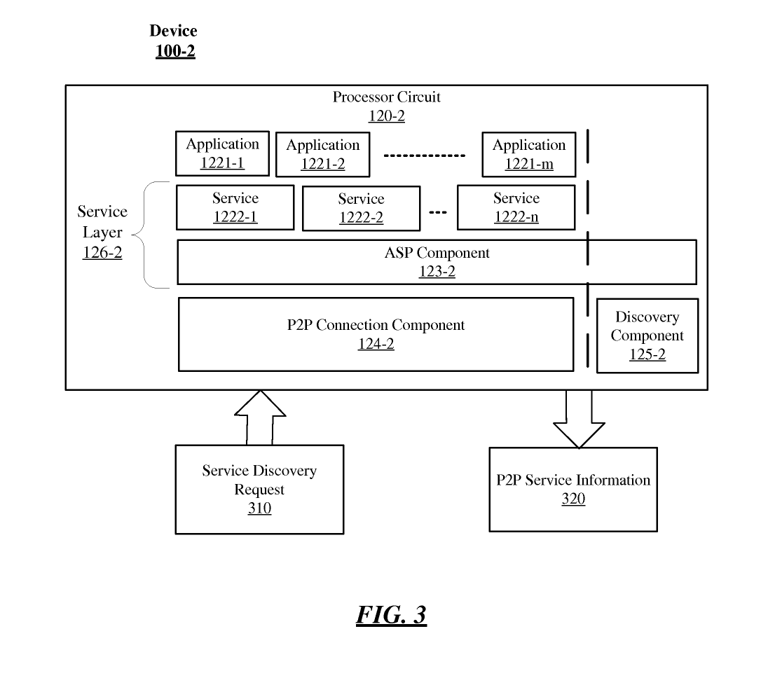

Each processor circuit 120-a includes a P2P connection component 124-a. The P2P connection component 124-a may comprise programming, functions, logic, parameters, and/or other information operative to implement particular capabilities for the devices 100-a. In particular, the P2P connection component 124-a can establish the P2P network 1000 and communicate signals over the network 1000 for the purposes of sharing services (e.g., refer to FIGS. 2-3).

The processor circuit 120-a includes a discovery component 125-a. The discovery component 125-a may comprise programming, functions, logic, parameters, and/or other information operative to implement particular capabilities for the devices 100-a. In particular, the discovery component 125-a can advertise, request information about, and/or discover services available over the P2P network 1000.

In general, during operation, the devices 100-a may transmit signals including indications of services available over the P2P network 1000 (shown as service discovery traffic 300) using the second radio 114-a. Based on these signals, the devices 100-a may form the P2P network 1000 and/or communicate in the P2P network 1000 using the first radios 112-a. In particular, a device may discover another devices' services and connection attributes available through the P2P network 100 (e.g., available over the first radio, which may be a Wi-Fi radio) using the second radio (e.g., the NFC radio).

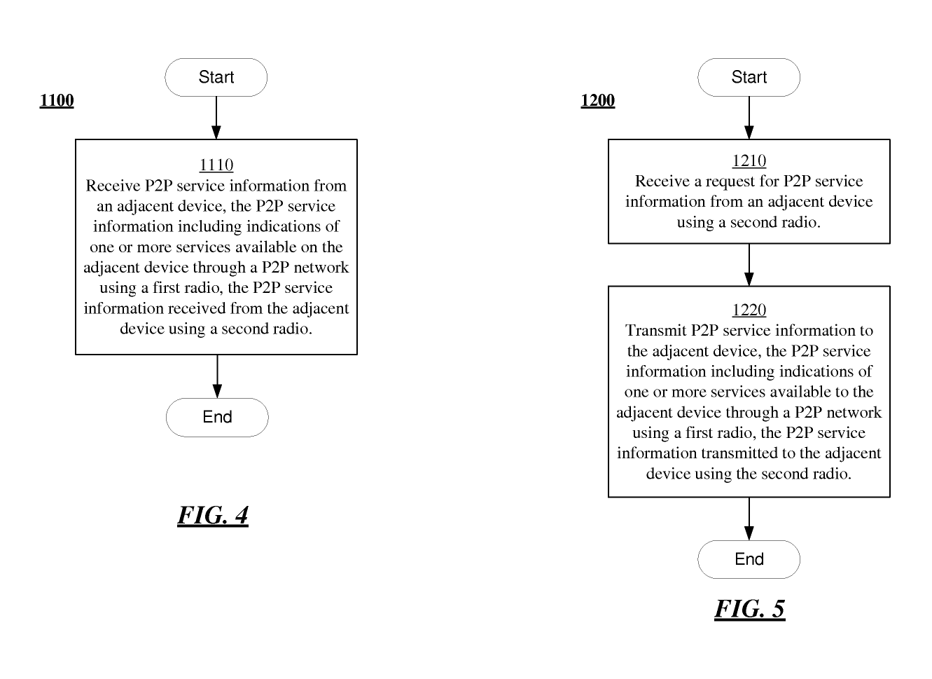

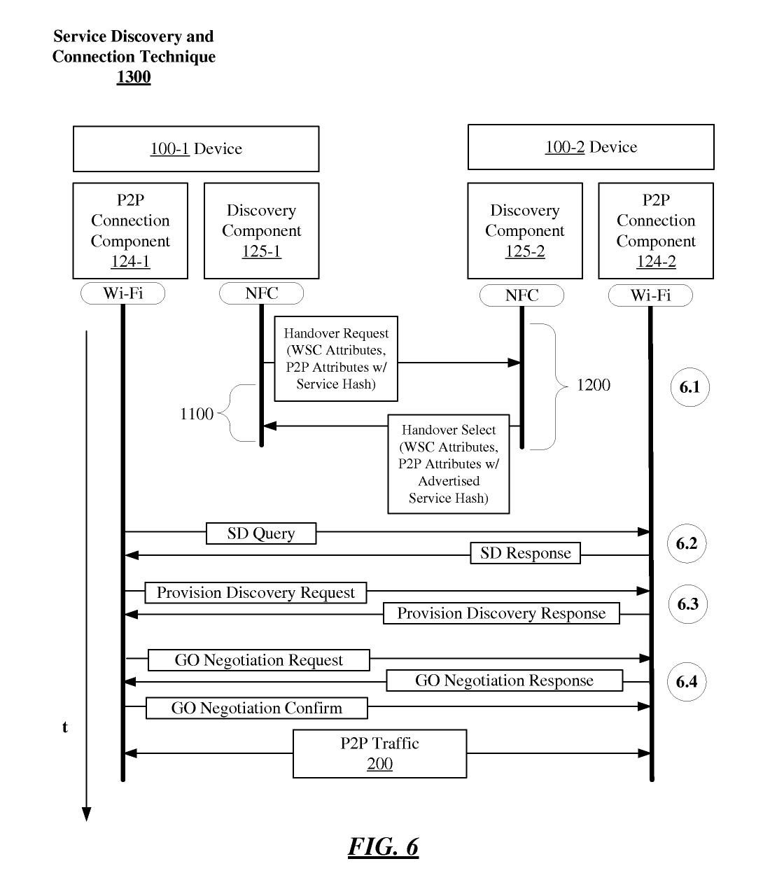

In general, each of the devices 100-a may operate to both discover an adjacent device and its services (e.g., refer to FIG. 4) and to be discovered by an adjacent device and provide information about available services to the discovering device (e.g., refer to FIG. 5). However, for purposes of explanation and clarity, the device 100-1 will be referred to as the “discovering device” and the device 100-2 will be referred to as the “discovered device”. It is to be appreciated that this is not intended to be limiting and is merely done for convenience in referring to the figures. Furthermore, it is to be appreciated, that the term adjacent is relative and used in the context of NFC radio. In particular, as will be appreciated, NFC radio operates of a small distance relative to radio-frequency (RF) signals in general. As such, use of the term “adjacent” and/or “adjacent device” indicates a device that sufficiently close to allow an NFC radio to send and/or receive signals. For example, with out limitation, devices that are adjacent in the context of NFC may be within 5 centimeters of each other, within 10 centimeters or each other, or another such distance in which the NFC radios are capable of communicating.

FIGS. 2-3 illustrate portions of the device 100-1 and 100-2 in greater detail. In particular, FIG. 2 illustrates the device 100-1 and the processor circuit 120-1 in greater detail, while FIG. 3 illustrates the device 100-2 and the processor circuit 120-2 in greater detail. In particular, FIGS. 2-3 illustrate example implementations of the devices 100-1 and 100-2, where the devices 100-1 and 100-2 are configured to discover services and connection attributes associated with the P2P network 1000.

As depicted, each processor circuit 120-a includes the discovery component 125-a and the P2P connection component 124-a. Additionally, each processor circuit 120-a may include a service layer 126-a. The service layer 126-a may include an application service platform (ASP) 123-a and various services (e.g., services 1212-1 to 1212-k, 1222-1 to 1222-n, or the like). Furthermore, each processor component 120-a may include applications (e.g., applications 1211-1 to 1211-j, 1221-1 to 1221-m, or the like). In some examples, the service layer 126-a may be a Wi-Fi Direct Service (WFDS) layer or simply the ASP layer.

In general, the applications (e.g., applications 1211-1 to 1211-j, 1221-1 to 1221-m) are configured to operate on the service layer 126-a to provide various functionality and/or features of the device 100-a. For example, the applications may include a print application, a file sharing application, a media streaming application, a display application, or the like. Furthermore, the applications may invoke and/or take advantage of services available on the device (e.g., services 1212-1 to 1212-k, 1222-1 to 1222-n). The ASP 123-a is configured to allow the services to be discovered and launched remotely through the P2P network 1000 (e.g., using the P2P connection component 124-a). The P2P connection component 124-a provides for communicatively coupling the device 100-a to another device 100-a through the P2P network 1000 using the first radio for purposes sharing services. The discovery component 125-a is configured to facilitate discovery of services (e.g., services 1212-1 to 1212-k, 1222-1 to 1222-n) and discovery of P2P network connection attributes using the second radio.

Turning more specifically to FIG. 2, during operation, the discovery component 125-1 can receive P2P service information 320 from an adjacent device (e.g., the device 100-2) using the second radio 114-1. The P2P service information 320 may include indications of a number of services (e.g., the services 1222-1 to 1222-m) available on the adjacent device through the P2P network 1000.

Additionally, the discovery component 125-1 may transmit a service discovery request 310 to the adjacent device (e.g., the device 100-2) using the second radio 114-1. The service discovery request 310 may include an indication of a desire to receive the P2P service information 320 from the adjacent device. Additionally, the discovery request may also include advertised services and connection attributes. More particular, the discovery request 310 may include both a request for services available on the adjacent device (e.g., the device 100-2) as well as an indication of services available on the requesting device (e.g., the device 100-1).

Turning more specifically to FIG. 3, during operation, the discovery component 125-2 can transmit P2P service information 320 to an adjacent device (e.g., the device 100-1) using the second radio 114-2. The P2P service information 320 may include indications of a number of services (e.g., the services 1222-1 to 1222-m) available to the adjacent device through the P2P network 1000.

Additionally, the discovery component 125-2 may receive a service discovery request 310 from the adjacent device (e.g., the device 100-1) using the second radio 114-2. The service discovery request 310 may include an indication of a desire to receive the P2P service information 320 from the adjacent device. Additionally, the discovery request may also include advertised services and connection attributes. More particular, the discovery request 310 may include both a request for services available on the adjacent device (e.g., the device 100-2) as well as an indication of services available on the requesting device (e.g., the device 100-1).

In some examples, the service discovery request 310 is a handover request frame while the P2P service information 320 is a handover select frame, such as, for example, handover request frames and handover select frames as described in the Wi-Fi Alliance Wi-Fi Peer-to-Peer (P2P) Technical Specification with NFC, v1.3, or NFC specifications.

In some examples, the handover request frame may include the Service Hash attribute as part of the P2P attributes transmitted in the handover request frame. In some examples, the handover request frame may include the wireless control system (WCS) attributes. Accordingly, the service discovery request may include both a request to discover services as well as an advertisement of available services.

In some examples, the handover select frame may include the advertised services information as part of the P2P attributes. In some examples, the handover select frame may include the WCS attributes.

Accordingly, service discovery and “pairing” may be facilitated using NFC. In particular, Wi-Fi Direct device discovery and configuration may be facilitated using NFC by transmitting and receiving the service discovery request 310 and the P2P service information 320 with the second radio 114-a.

FIGS. 4-5 illustrate examples of logic flows representative of at least some operations executed by one or more logic, features, or devices described herein. In general, the logic flows may be representative of some or all of the operations executed by logic and/or features of the devices 100-a of the system 1000. In particular, FIG. 4 may be representative of operations performed by the device 100-1 in discovering services and connection attributes of the device 100-2 while FIG. 5 may be representative of operations performed by the device 100-2 in advertising it services and connection attributes. It is to be appreciated, that although the example logic flows are described with reference to the system 1000 of FIGS. 1-3, this is not intended to be limiting and is merely done for clarity of presentation.

Turning more specifically to FIG. 4, a logic flow 1100 is depicted. The logic flow 1100 may begin at block 1110. At block 1110, “receive P2P service information from an adjacent device, the P2P service information including indications of one or more services available on the adjacent device through a P2P network using a first radio, the P2P service information received from the adjacent device using a second radio” the device 100-1 may receive P2P service information including an indication of services available on the P2P network 1000 and connection attributes for the network 1000 using the second radio 114-1. In particular, the discovery component 125-1 may receive the P2P service information 320 from the device 100-1 using the second radio 114-1.

Turning more specifically to FIG. 5, a logic flow 1200 is depicted. The logic flow 1200 may begin at block 1210. At block 1210, “receive a request for P2P service information from an adjacent device using a second radio” the device 100-2 may receive a request for P2P service information using the second radio 114-2. In particular, the discovery component 125-2 may receive the service discovery request 310 from the device 100-1 using the second radio 114-1.

Continuing to block 1220, “transmit P2P service information to an adjacent device, the P2P service information including indications of one or more services available to the adjacent device through a P2P network using a first radio, the P2P service information transmitted to the adjacent device using a second radio” the device 100-2 may transmit P2P service information including an indication of services available on the P2P network 1000 and connection attributes for the network 1000 using the second radio 114-1. In particular, the discovery component 125-2 may transmit the P2P service information 320 to the device 100-1 using the second radio 114-1.

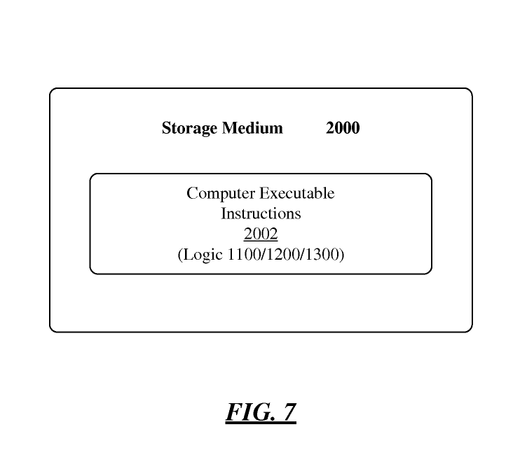

FIG. 6 illustrates an example service discovery and connection technique 1300. In some examples, the devices 100-a can implement the technique 1300. In particular, the acts depicted in the technique 1300 may be representative of a technique such as may be performed in various embodiments of the present disclosure. More particularly, the technique 1300 may be representative of a service discovery and connection procedure during which P2P networks services and P2P network connection attributes are communicated using the second radios 114-a to facilitate establishing and/or communicating in the P2P network using the first radio 112-a.

In the technique 1300, communications regarding a Wi-Fi P2P network and services available over the network are exchanged between the devices 100-1 and 100-2 using NFC radios. Said differently, the devices 100-1 and 100-2 may “pair” with each other over NFC for purposes of establishing a P2P network over Wi-Fi.

In particular, the technique 1300 at process 6.1, the device 100-1 and the device 100-2 communicate information about the services (e.g., services 1212-1 to 1212-k, 1222-1 to 1222-n) available on the P2P network 1000 using the second radio 114-1 and 114-2, which can be an NFC radio. In particular, at process 6.1, the device 100-1 may perform operations of the logic flow 1100, while the device 100-2 may perform operations of the logic flow 1200.

Continuing to process 6.2, the device 100-1 and the device 100-2 may conduct service discovery (SD) over Wi-Fi (e.g., using the first radio 112-a) using the P2P network information exchanged during process 6.1. Continuing to process 6.3, the device 100-1 and the device 100-2 may conduct provisioning discovery over Wi-Fi (e.g., using the first radio 112-a) using the P2P network information exchanged during process 6.1. Continuing to process 6.4, the device 100-1 and the device 100-2 may form the P2P network 1000 over Wi-Fi (e.g., using the first radio 112-a) using the P2P network information exchanged during process 6.1.

FIG. 7 illustrates an embodiment of a storage medium 2000. The storage medium 2000 may comprise an article of manufacture. In some examples, the storage medium 2000 may include any non-transitory computer readable medium or machine readable medium, such as an optical, magnetic or semiconductor storage. The storage medium 2000 may store various types of computer executable instructions e.g., 2002). For example, the storage medium 2000 may store various types of computer executable instructions to implement logic flow 1100. In some examples, the storage medium 2000 may store various types of computer executable instructions to implement logic flow 1200. In some examples, the storage medium 2000 may store various types of computer executable instructions to implement logic flow 1300.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

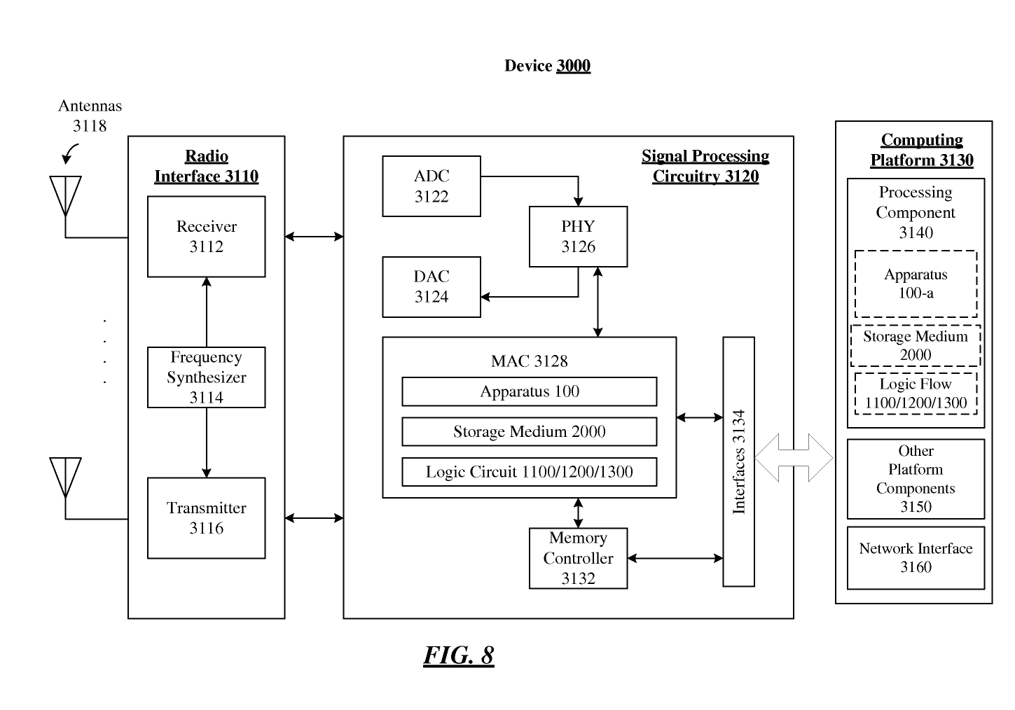

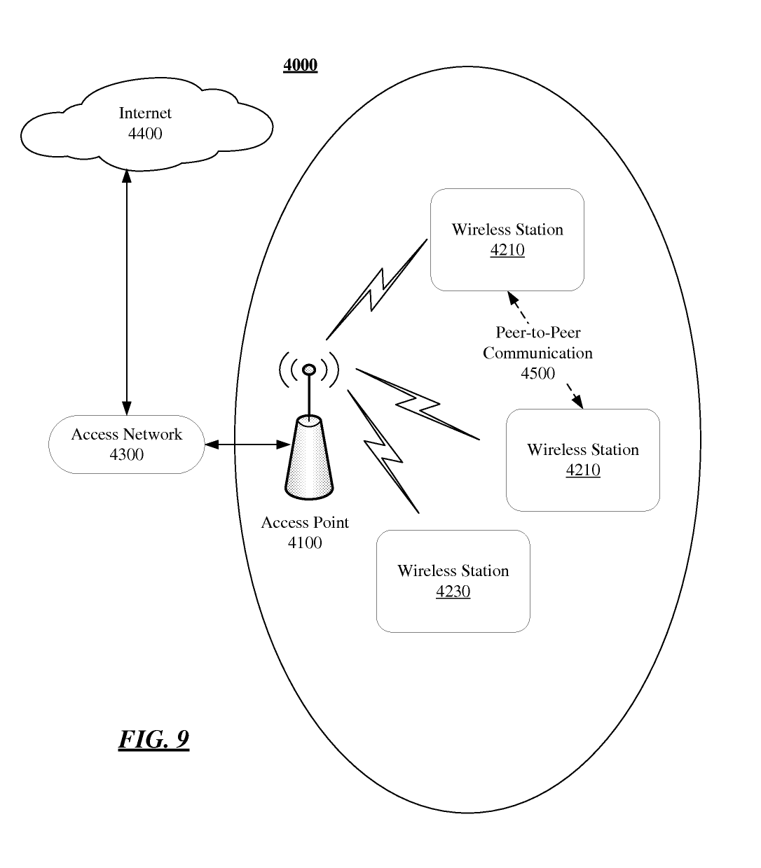

FIG. 8 illustrates an embodiment of a device 3000. In some examples, device 3000 may be configured or arranged for wireless communications in a P2P network such as the P2P network 1000 shown in FIG. 1. In some examples, one of the devices 100-a may be implemented in the device 3000. For example, the device 3000 may implement the device as apparatus 100-a. Additionally, the device 3000 may implement storage medium 2000 and/or a logic circuit 1100/1200/1300. The logic circuits may include physical circuits to perform operations described for the apparatus 100-a, storage medium 2000, logic flow 1100, logic flow 1200, and/or logic flow 1300. As shown in FIG. 8, device 3000 may include a radio interface 3110, baseband circuitry 3120, and computing platform 3130, although examples are not limited to this configuration.

The device 3000 may implement some or all of the structure and/or operations for the apparatus 100-a, the storage medium 2000 and/or the logic circuit 1100/1200/1300 in a single computing entity, such as entirely within a single device. The embodiments are not limited in this context.

Radio interface 3110 may include a component or combination of components adapted for transmitting and/or receiving single carrier or multi-carrier modulated signals (e.g., including complementary code keying (CCK) and/or orthogonal frequency division multiplexing (OFDM) symbols and/or single carrier frequency division multiplexing (SC-FDM symbols) although the embodiments are not limited to any specific over-the-air interface or modulation scheme. Radio interface 3110 may include, for example, a receiver 3112, a transmitter 3116 and/or a frequency synthesizer 3114. Radio interface 3110 may include bias controls, a crystal oscillator and antennas 3118-1 to 3118-f. In another embodiment, radio interface 3110 may use external voltage-controlled oscillators (VCOs), surface acoustic wave filters, intermediate frequency (IF) filters and/or RF filters, as desired. Due to the variety of potential RF interface designs, an expansive description thereof is omitted.

Baseband circuitry 3120 may communicate with radio interface 3110 to process receive and/or transmit signals and may include, for example, an analog-to-digital converter 3122 for down converting received signals, a digital-to-analog converter 3124 for up converting signals for transmission. Further, baseband circuitry 3120 may include a baseband or physical layer (PHY) processing circuit 3126 for PHY link layer processing of respective receive/transmit signals. Baseband circuitry 3120 may include, for example, a processing circuit 3128 for medium access control (MAC)/data link layer processing. Baseband circuitry 3120 may include a memory controller 3132 for communicating with MAC processing circuit 3128 and/or a computing platform 3130, for example, via one or more interfaces 3134.

In some embodiments, PHY processing circuit 3126 may include a frame construction and/or detection module, in combination with additional circuitry such as a buffer memory, to construct and/or deconstruct communication frames (e.g., containing subframes). Alternatively or in addition, MAC processing circuit 3128 may share processing for certain of these functions or perform these processes independent of PHY processing circuit 3126. In some embodiments, MAC and PHY processing may be integrated into a single circuit.

Computing platform 3130 may provide computing functionality for device 3000. As shown, computing platform 3130 may include a processing component 3140. In addition to, or alternatively of, baseband circuitry 3120 of device 3000 may execute processing operations or logic for the apparatus 100a, storage medium 2000, and logic circuits 1100/1200/1300 using the processing component 3130. Processing component 3140 (and/or PHY 3126 and/or MAC 3128) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Computing platform 3130 may further include other platform components 3150. Other platform components 3150 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Computing platform 3130 may further include a network interface 3160. In some examples, network interface 3160 may include logic and/or features to support network interfaces operated in compliance with one or more wireless broadband technologies such as those described in one or more standards associated with IEEE 802.11 such as IEEE 802.11u or with technical specification such as WFA Hotspot 2.0.

Device 3000 may be part of a device in a P2P network and may be included in various types of computing devices to include, but not limited to, user equipment, a computer, a personal computer (PC), a desktop computer, a laptop computer, a notebook computer, a netbook computer, a tablet computer, an ultra-book computer, a smart phone, embedded electronics, a gaming console, a server, a server array or server farm, a web server, a network server, an

Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of device 2000 described herein; may be included or omitted in various embodiments of device 2000, as suitably desired. In some embodiments, device 2000 may be configured to be compatible with protocols and frequencies associated with IEEE 802.11 Standards or Specification and/or 3GPP Standards or Specifications for MIMO systems, although the examples are not limited in this respect.

The components and features of device 3000 may be implemented using any combination of discrete circuitry, application specific integrated circuits (ASICs), logic gates and/or single chip architectures. Further, the features of device 3000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 3000 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

FIG. 9 illustrates an embodiment of a wireless network 4000. As shown in FIG. 7, wireless network 4000 comprises an access point 4100 and wireless stations 4210, 4220, and 4230. In various embodiments, wireless network 4000 may comprise a wireless local area network (WLAN), such as a WLAN implementing one or more Institute of Electrical and Electronics Engineers (IEEE) 802.11 standards (sometimes collectively referred to as “Wi-Fi”). In some other embodiments, wireless network 4000 may comprise another type of wireless network, and/or may implement other wireless communications standards. In various embodiments, for example, wireless network 4000 may comprise a WWAN or WPAN rather than a WLAN. The embodiments are not limited to this example.

In some embodiments, wireless network 4000 may implement one or more broadband wireless communications standards, such as 3G or 4G standards, including their revisions, progeny, and variants. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1xRTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The embodiments are not limited in this context.

In various embodiments, wireless stations 4210, 4220, and 4230 may communicate with access point 4100 in order to obtain connectivity to one or more external data networks. In some embodiments, for example, wireless stations 4210, 4220, and 4230 may connect to the Internet 4400 via access point 4100 and access network 4300. In various embodiments, access network 4300 may comprise a private network that provides subscription-based Internet-connectivity, such as an Internet Service Provider (ISP) network. The embodiments are not limited to this example.

In various embodiments, two or more of wireless stations 4210, 4220, and 4230 may communicate with each other directly by exchanging peer-to-peer communications. For example, as depicted in FIG. 9, wireless stations 4210 and 4220 communicate with each other directly by exchanging peer-to-peer (P2P) communications 4500. In some examples, the P2P communications 4500 may be established using the techniques described herein. More specifically, some examples services available to share using the P2P communications 4500 may be advertised and/or discovered using the techniques discussed herein. In particular, NFC radios may be used to “pair” the wireless stations 4210 and 4220 for purposes of establishing the P2P communication 4500.

In some embodiments, such peer-to-peer communications may be performed according to one or more Wi-Fi Alliance (WFA) standards. For example, in various embodiments, such peer-to-peer communications may be performed according to the WFA Wi-Fi Direct standard, 2010 Release. In various embodiments, such peer-to-peer communications may additionally or alternatively be performed using one or more interfaces, protocols, and/or standards developed by the WFA Wi-Fi Direct Services (WFDS) or ASP2 programs. In various embodiments, such peer-to-peer communications may be performed according to the WFA NAN protocol. The embodiments are not limited to these examples.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose might be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Example 1: An apparatus for a device in a wireless network, the apparatus including circuitry; a peer-to-peer (P2P) connection component executable by the circuitry, the P2P connection component to connect to a P2P network using a first radio; and a discovery component executable by the circuitry, the discovery component to receive P2P service information from a device using a second radio, the P2P service information including indications of one or more services available on the device through the P2P network.

Example 2: The apparatus of example 1, the discovery component to transmit a service discovery request to the device using the second radio, the service discovery request including an indication of a request to receive P2P service information from the device.

Example 3: The apparatus of example 2, the first radio to comprise a Wi-Fi radio.

Example 4: The apparatus of example 3, the P2P network to comprise a Wi-Fi Direct network.

Example 5: The apparatus of example 4, the second radio to comprise a near field communication (NFC) radio.

Example 6: The apparatus of example 5, wherein the service discovery request is a handover request frame.

Example 7: The apparatus of example 6, wherein handover request frame includes a P2P attributes portion, the P2P attributes including an indication of a service hash.

Example 8: The apparatus of example 5, wherein the P2P service information is a handover select frame.

Example 9: The apparatus of example 8, wherein the handover select frame includes a P2P attributes portion, the P2P attributes portion including an indication of the services available on the device through the P2P network.

Example 10: The apparatus of any one of examples 1 to 9, the discovery component to send a control directive to power on the second radio in order to receive the P2P service information.

Example 11: The apparatus of any one of examples 1 to 9, further including a first antenna array operably coupled to the first radio; and a second antenna array operably coupled to the second radio.

Example 12: The apparatus of any one of examples 1 to 9, further including a first antenna array operably coupled to the first radio and the second radio.

Example 13: The apparatus of any one of examples 1 to 9, the circuitry to comprise an application processor.

Example 14: The apparatus of any one of examples 1 to 9, the circuitry to comprise a baseband processor.

Example 15: An apparatus for a device in a wireless network, the apparatus including circuitry; and a peer-to-peer (P2P) connection component executable by the circuitry, the P2P connection component to connect to a P2P network using a first radio; and a discovery component executable by the circuitry, the discovery component to transmit P2P service information to an device using a second radio, the P2P service information including indications of one or more services available to the device through the P2P network.

Example 16: The apparatus of example 15, the discovery component to receive a service discovery request from the device using the second radio, the service discovery request including an indication of a request to receive P2P service information.

Example 17: The apparatus of example 16, the first radio to comprise a Wi-Fi radio.

Example 18: The apparatus of example 17, the P2P network to comprise a Wi-Fi Direct network.

Example 19: The apparatus of example 18, the second radio to comprise a near field communication (NFC) radio.

Example 20: The apparatus of example 19, wherein the service discovery request is a handover request frame.

Example 21: The apparatus of example 20, wherein handover request frame includes a P2P attributes portion, the P2P attributes including an indication of a service hash.

Example 22: The apparatus of example 19, wherein the P2P service information is a handover select frame.

Example 23: The apparatus of example 22, wherein the handover select frame includes a P2P attributes portion, the P2P attributes portion including an indication of the services available to the device through the P2P network.

Example 24: The apparatus of any one of examples 15 to 23, the discovery component to send a control directive to power on the second radio in order to transmit the P2P service information.

Example 25: The apparatus of any one of examples 15 to 23, further including a first antenna array operably coupled to the first radio; and a second antenna array operably coupled to the second radio.

Example 26: The apparatus of any one of examples 15 to 23, further including a first antenna array operably coupled to the first radio and the second radio.

Example 27: The apparatus of any one of examples 15 to 23, the circuitry to comprise an application processor.

Example 28: The apparatus of any one of examples 15 to 23, the circuitry to comprise a baseband processor.

Example 29: A method implemented by a device in a wireless network, the method including receiving peer-to-peer (P2P) service information from an device, the P2P service information including indications of one or more services available on the device through a P2P network using a first radio, the P2P service information received from the device using a second radio.

Example 30: The method of example 29, comprising transmitting a service discovery request to the device using the second radio, the service discovery request including an indication of a request to receive P2P service information from the device.

Example 31: The method of example 30, the first radio comprising a Wi-Fi radio.

Example 32: The method of example 31, the P2P network comprising a Wi-Fi Direct network.

Example 33: The method of example 32, the second radio comprising a near field communication (NFC) radio.

Example 34: The method of example 33, wherein the service discovery request is a handover request frame.

Example 35: The method of example 34, wherein handover request frame includes a P2P attributes portion, the P2P attributes including an indication of a service hash.

Example 36: The method of example 33, wherein the P2P service information is a handover select frame.

Example 37: The method of example 36, wherein the handover select frame includes a P2P attributes portion, the P2P attributes portion including an indication of the services available on the device through the P2P network.

Example 38: The method of any one of examples 29 to 37, comprising sending a control directive to power on the second radio in order to receive the P2P service information.

Example 39: A method implemented by a device in a wireless network, the method including transmitting peer-to-peer (P2P) service information to a device, the P2P service information including indications of one or more services available to the device through a P2P network using a first radio, the P2P service information transmitted to the device using a second radio.

Example 40: The method of example 39, comprising receiving a service discovery request from the device using the second radio, the service discovery request including an indication of a request to receive P2P service information.

Example 41: The method of example 40, the first radio to comprise a Wi-Fi radio.

Example 42: The method of example 41, the P2P network to comprise a Wi-Fi Direct network.

Example 43: The method of example 42, the second radio to comprise a near field communication (NFC) radio.

Example 44: The method of example 43, wherein the service discovery request is a handover request frame.

Example 45: The method of example 44, wherein handover request frame includes a P2P attributes portion, the P2P attributes including an indication of a service hash.

Example 46: The method of example 43, wherein the P2P service information is a handover select frame.

Example 47: The method of example 46, wherein the handover select frame includes a P2P attributes portion, the P2P attributes portion including an indication of the services available to the device through the P2P network.

Example 48: The method of any one of examples 29 to 47, comprising sending a control directive to power on the second radio in order to transmit the P2P service information.

Example 49: An apparatus for a device in a wireless network, the apparatus comprising means to perform the method of any of examples 29 to 48.

Example 50: At least one machine readable medium comprising a plurality of instructions that in response to being executed on a transmitter node and/or a receiver node in a wireless network cause any one the transmitter node and/or receiver node to perform the method of any of examples 29 to 48.

Example 51: An apparatus for a wireless network including a processor; a radio operably connected to the processor; one or more antennas operably connected to the radio to transmit or receive wireless signals; and a memory comprising a plurality of instructions that in response to being executed by the processor cause the processor or the radio to perform the method of any of examples 29 to 48.

1. An apparatus for a device in a wireless network, the apparatus comprising:
circuitry;
a peer-to-peer (P2P) connection component executable by the circuitry, the P2P connection component to connect to a P2P network using a first radio; and
a discovery component executable by the circuitry, the discovery component to receive P2P service information from a device using a second radio, the P2P service information including indications of one or more services available on the device through the P2P network.

2. The apparatus of claim 1, the discovery component to transmit a service discovery request to the device using the second radio, the service discovery request including an indication of a request to receive P2P service information from the device.

3. The apparatus of claim 2, the first radio to comprise a Wi-Fi radio and the P2P network to comprise a Wi-Fi Direct network.

4. The apparatus of claim 3, the second radio to comprise a near field communication (NFC) radio.

5. The apparatus of claim 4, wherein the service discovery request is a handover request frame and wherein handover request frame includes a P2P attributes portion, the P2P attributes including an indication of a service hash.

6. The apparatus of claim 4, wherein the P2P service information is a handover select frame and wherein the handover select frame includes a P2P attributes portion, the P2P attributes portion including an indication of the services available on the device through the P2P network.

7. The apparatus of claim 1, the discovery component to send a control directive to power on the second radio in order to receive the P2P service information.

8. The apparatus of claim 1, further comprising:
a first antenna array operably coupled to the first radio; and
a second antenna array operably coupled to the second radio.

9. The apparatus of claim 1, further comprising:
a first antenna array operably coupled to the first radio and the second radio.

10. The apparatus of claim 1, the circuitry to comprise an application processor or a baseband processor.

11. An apparatus for a device in a wireless network, the apparatus comprising:
circuitry; and
a peer-to-peer (P2P) connection component executable by the circuitry, the P2P connection component to connect to a P2P network using a first radio; and
a discovery component, the discovery component to transmit P2P service information to a device using a second radio, the P2P service information including indications of one or more services available to the device through the P2P network.

12. The apparatus of claim 11, the discovery component to receive a service discovery request from the device using the second radio, the service discovery request including an indication of a request to receive P2P service information.

13. The apparatus of claim 12, the first radio to comprise a Wi-Fi radio and the P2P network to comprise a Wi-Fi Direct network.

14. The apparatus of claim 13, the second radio to comprise a near field communication (NFC) radio.

15. The apparatus of claim 14, wherein the service discovery request is a handover request frame and wherein handover request frame includes a P2P attributes portion, the P2P attributes including an indication of a service hash.

16. The apparatus of claim 14, wherein the P2P service information is a handover select frame and wherein the handover select frame includes a P2P attributes portion, the P2P attributes portion including an indication of the services available to the device through the P2P network.

17. The apparatus of claim 11, the discovery component to send a control directive to power on the second radio in order to transmit the P2P service information.

18. The apparatus of claim 11, further comprising:
a first antenna array operably coupled to the first radio; and
a second antenna array operably coupled to the second radio.

19. The apparatus of claim 11, the circuitry to comprise an application processor or a baseband processor.

20. A method implemented by a device in a wireless network, the method comprising:
receiving peer-to-peer (P2P) service information from a device, the P2P service information including indications of one or more services available on the device through a P2P network using a first radio, the P2P service information received from the device using a second radio.

21. The method of claim 20, comprising transmitting a service discovery request to the device using the second radio, the service discovery request including an indication of a request to receive P2P service information from the device.

22. The method of claim 20, wherein the service discovery request is a handover request frame, the handover request frame including a P2P attributes portion, the P2P attributes including an indication of a service hash and wherein the P2P service information is a handover select frame, the handover select frame including a P2P attributes portion, the P2P attributes portion including an indication of the services available on the device through the P2P network.

23. At least one machine readable medium comprising a plurality of instructions that in response to being executed on a wireless device cause the wireless device to:
receive a service discovery request from a device, the service discovery request including an indication of a request to receive peer-to-peer (P2P) service information; and
transmit P2P service information to the device, the P2P service information including indications of one or more services available to the device through a P2P network using a first radio, the service discovery request received from the device using a second radio and the P2P service information transmitted to the device using the second radio.

24. The method of claim 23, the first radio comprising a Wi-Fi radio, the second radio comprising a near field communication (NFC) radio, and the P2P network comprising a Wi-Fi Direct network.

25. The method of claim 24, wherein the service discovery request is a handover request frame and the P2P service information is a handover select frame.
